(19) United States
(12) Patent Application Publication
(10) Pub. No.: US 2011/0242507 A1
(43) Pub. Date: Oct. 6, 2011

(54) SPORTS PROJECTION SYSTEM

(76) Inventor: Scott Smith, Temperance, MI (US)

(21) Appl. No.: 13/076,404

(22) Filed: Mar. 30, 2011

Related U.S. Application Data
(60) Provisional application No. 61/318,889, filed on Mar. 30, 2010.

(51) Int. Cl. G03B 21/14

(52) U.S. Cl. 353/121

(57) ABSTRACT

A method of facilitating athletic training is disclosed herein. The method includes the step of projecting an image downwardly on a surface. The projected image displays a plurality of indicia including at least one position indicia corresponding to a participant of an athletic activity and at least one reference indicia at least partially spaced from the at least one position indicia.

### CROSS-REFERENCE TO RELATED APPLICATIONS

This application claims the benefit of U.S. Provisional Patent Application Ser. No. 61/318,889 for a SPORTS PROJECTION SYSTEM, filed on Mar. 20, 2010, which is hereby incorporated by reference in its entirety.

### BACKGROUND OF THE INVENTION

1. Field of the Invention

The invention relates to a system for athletic training.

2. Description of Related Prior Art

U.S. Pat. No. 7,359,121 discloses a system and method for tracking and assessing movement skills in multidimensional space. The system seeks to provide accurate simulation of sport to quantify and train performance constructs by employing sensing electronics for determining, in essentially real time, the player's three dimensional positional changes in three or more degrees of freedom (three dimensions); and computer controlled sport specific cuing that evokes or prompts sport specific responses from the player that are measured to provide meaningful indicia of performance. The sport specific cuing is characterized as a virtual opponent that is responsive to, and interactive with, the player in real time. The virtual opponent continually delivers and/or responds to stimuli to create realistic movement challenges for the player.

### SUMMARY OF THE INVENTION

In summary, the invention is a method of facilitating athletic training The method includes the step of projecting an image downwardly on a surface. The projected image displays a plurality of indicia including at least one position indicia corresponding to a participant of an athletic activity and at least one reference indicia at least partially spaced from the at least one position indicia.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a first embodiment of the invention;

FIG. 2 is a top-down view of a first exemplary image produced by an embodiment of the invention;

FIG. 3 is a top-down view of a second exemplary image produced by an embodiment of the invention;

FIG. 4 is a top-down view of a third exemplary image produced by an embodiment of the invention;

FIG. 5 is a top-down view of a fourth exemplary image produced by an embodiment of the invention;

FIG. 6 is a schematic representation of a second embodiment of the invention; and

FIG. 7 is a perspective view of the second embodiment of the invention.

### DETAILED DESCRIPTION OF EXEMPLARY EMBODIMENTS

The invention provides a sport projection system for athletic training In general, a two dimensional image is projected onto a surface. The surface is traversed by at least one participant of athletic training The image shows a path of movement for at least one participant of athletic training and/or an appropriate position for at least one participant of athletic training The image corresponds in size to an actual size of athletic field or to a portion of an athletic field. As used herein, “field” refers to any surface on which a sport is played, including but not limited to a field, a court, a diamond, a track, and a rink.

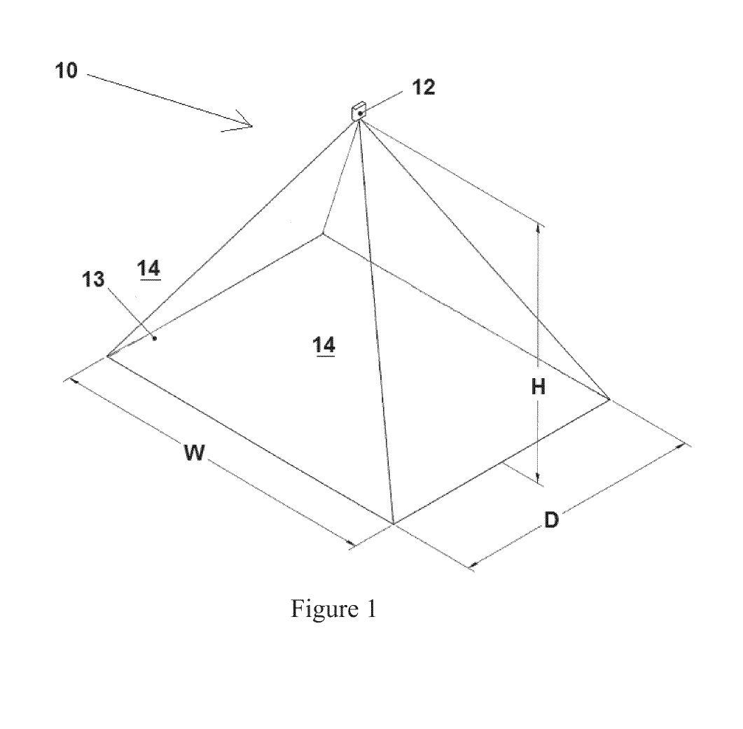

FIG. 1 shows a perspective view of a first embodiment of the invention. A sports projection system 10 can include a projector 12 operable to project an image 13 on a field 14. The exemplary projector can be positioned a height H of twenty (20) feet above the field 14. The exemplary image 13 can have a width W of twenty-five (25) feet and a depth D of nineteen (19) feet.

The level of light from the projector 12 can be determined based on ambient conditions. The amount of light provided by the projector 12 affects image visibility and size. The number of “lumens” indicates the amount of light coming from a lens of the projector 12. An image can be composed of dark areas where light is not present or other areas where there is a color such as red or green. Generally, a projector is rated for the maximum amount of light with a full white image. The projector 12 can provide a certain number of lumens. The lumens are distributed over the image area. The number of lumens necessary for practicing the invention can be determined in view of the operating environment. For example, if the field 14 is not indoors or enclosed, a projector providing a relatively high number of lumens may be preferred. Alternatively, if the field 14 is indoors or enclosed, a projector providing a lower number of lumens may allow for an acceptably-performing embodiment of the invention.

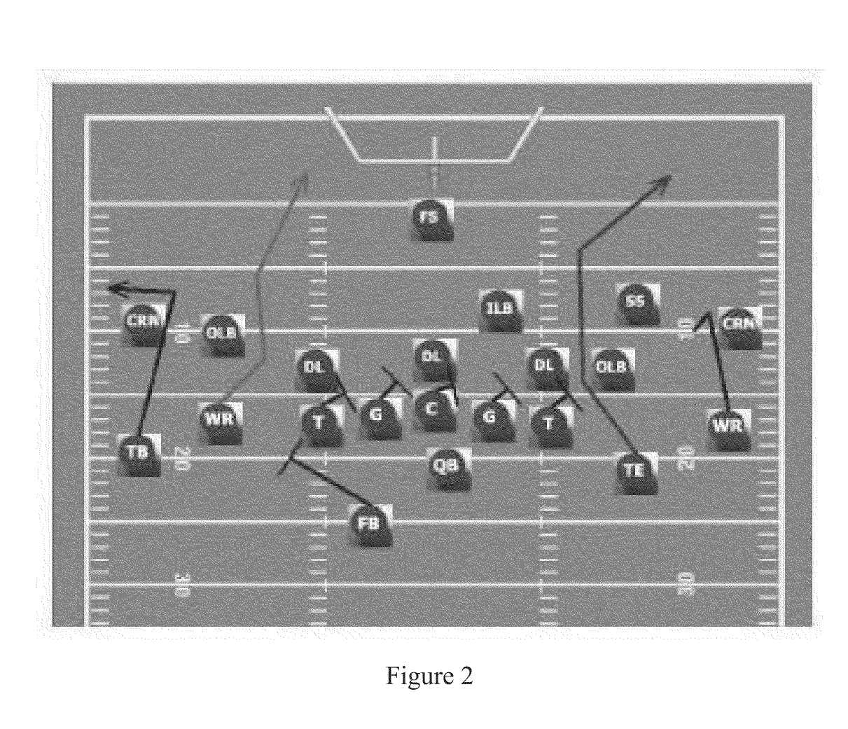

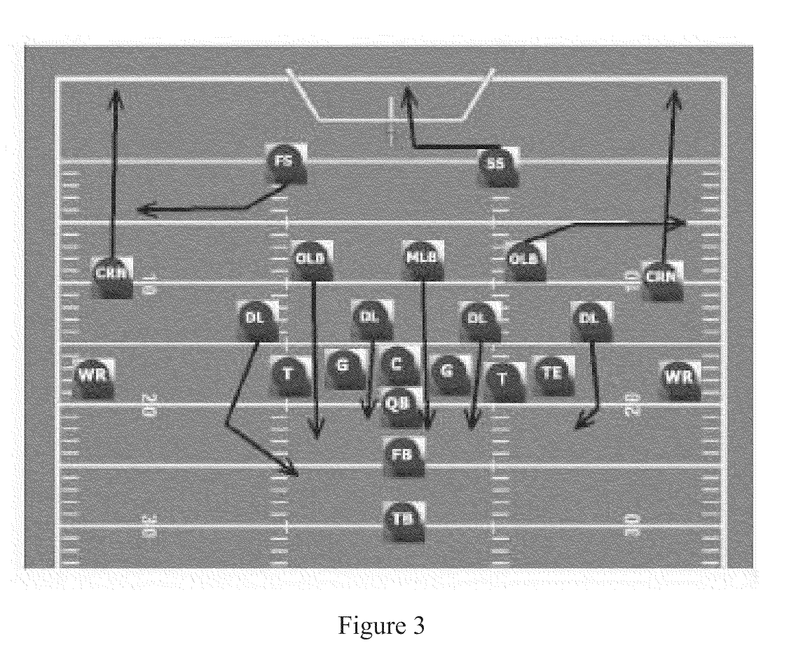

FIGS. 2 and 3 show exemplary images that can be produced according to an embodiment of the invention. The images of FIGS. 2 and 3 can be projected on a football field. Circles with letters can define starting positions for the participants of the athletic football training Lines extending from the circles can define paths of movement for the participants. The length of the lines can correspond to the actual paths of travel to be taken by the respective participants. The participants can thus get a sense of distance, timing and interaction when doing walkthroughs. FIG. 2 is of an exemplary offensive football play and FIG. 3 is of an exemplary defensive football play.

The system 10 projects the image 13 downwardly on the surface 14. The projected image 13 displays a plurality of indicia including at least one position indicia corresponding to a participant of an athletic activity and at least one reference indicia at least partially spaced from the at least one position indicia. The position indicia indicate(s) where a player should be or where a player should move. In FIGS. 2 and 3, the circled letters are position indicia. The solid lines extending from the circled letters can also be viewed as position indicia since the player should move through the positions defined along the solid lines. Embodiments of the invention can display position indicia as a solid and nonlinear geometric shape such as, by way of example and not limitation, a circle, a square, a rectangle, an oval, a triangle and an alphanumeric character. Alternatively, embodiments of the invention can display position indicia as a solid or dashed line or as a combination of line and solid and nonlinear geometric shape.

The reference indicia can take numerous forms in embodiments of the invention such as, by way of example and not limitation, a line, circle, a square, a rectangle, an oval, a piece of athletic equipment (hoop, goal, goal posts, etc.), and a triangle. The reference indicia can be boundary lines of the field of play. The reference indicia can represent structures on the field of play (a hoop, a goal, a net). In FIGS. 2 and 3, the reference indicia correspond to yardage lines of a football field arranged to scale.

The position indicia is at least partially spaced from the reference indicia in that it may be desired that the player pass across a reference indicia during game play. It may be desirable that the player position indicia always be spaced from the reference indicia. For example, it may not be desirable to display a position indicia to overlap a portion of a boundary line reference indicia. On the other hand, it may be desirable to display a position indicia to overlap a portion of a football yardage line reference indicia, a basketball center line reference indicia, a baseball base reference indicia, or a hockey blue line reference indicia.

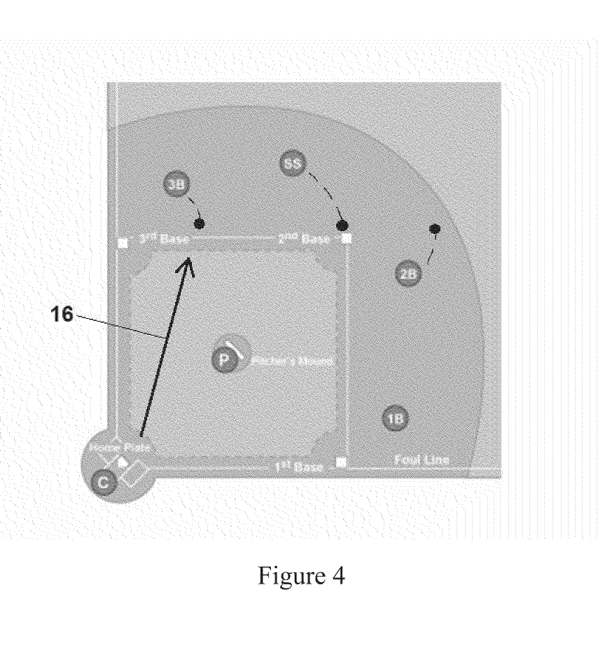

Embodiments of the invention can project relatively static images such as those shown in FIGS. 2 and 3, or a sequence of different images. FIG. 4 shows another image that can be projected on a surface. The image is a baseball diamond. The reference indicia corresponds to foul lines and bases of a baseball diamond arranged to scale. The position indicia corresponds to participants of a baseball game, including a third baseman, a shortstop, and a second baseman. In one embodiment of the invention, a portion of the image can represent the path of a ball that has been hit by a batter. For example, the arrow 16 can represent the path of movement of a ball hit by a batter. Other portions of the image can represent how each infield position player should respond to the path of the ball. The dashed lines extending from the respective infield positions and ending in solid circles represent how each player should move in response to the movement of the ball.

The system 10 can cause the arrow 16 to extend or lengthen over time, allowing the players to gain a sense of timing. In other embodiments of the invention, the arrow 16 could be replaced with an image resembling a ball. The ball or arrow would be a reference indicia and could appear to move within the image over a period of time perceivable by the participant. In other words, in embodiment of the invention an arrow could lengthen over a period of time similar to the period of time similar to the time a ball might take to travel after being hit or bunted. Similarly, a reference indicia of a ball could be displayed such that the ball moves at the speed a real ball would move. Also, the dashed lines extending from the respective infield positions could extend or lengthen over a period of time perceivable by the participant. Every participant can view how each position responds to the particular path. Thus, embodiments of the invention can run real time plays, sequences of images, and scenarios to verify players understand how to move.

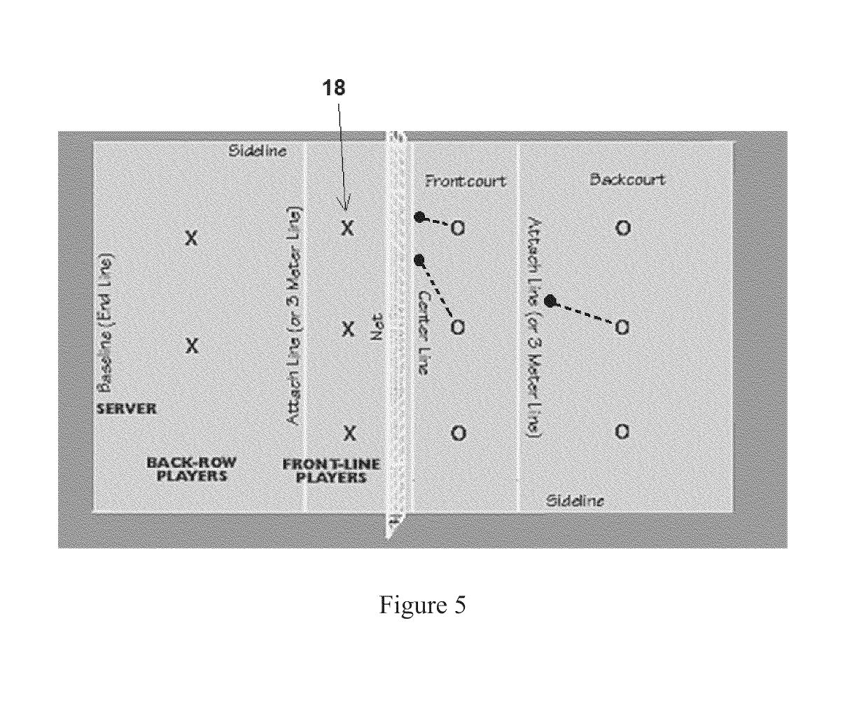

FIG. 5 shows another image that can be projected on a surface. The image is a volleyball court. In FIG. 5, the reference indicia includes boundary lines and a net of a volleyball court arranged to scale. The position indicia corresponds to participants of a volleyball game and are alphanumeric characters. In one embodiment of the invention, a portion of the image can represent the position of a player spiking the ball. The players are represented by various “X” and “O” on the image. The player X referenced at 18 can be the spiker. The dashed lines extending from the respective opposing players O and ending in solid circles represent how each of these players should move in preparation for defending against the spike. As shown in both FIGS. 4 and 5, the image can include text to assist the players in understanding the terminology of the game.

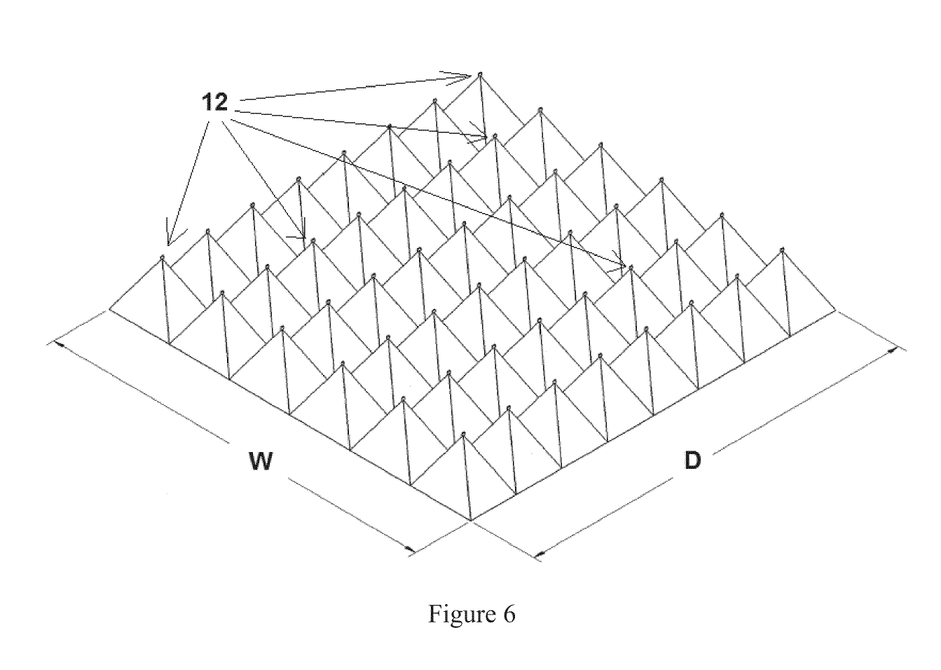

FIGS. 6 shows an embodiment of the invention practiced with multiple projectors linked together. A plurality of projectors 12 can be positioned in an array such that the respective images generated by each projector 12 are tiled on the surface. In other words, the image from each projector can correspond to one another and cooperate to define a composite image. For example, each projector can generate an image that corresponds to a portion of a football field. The projectors cooperating together could generate an entire football field to scale or less than an entire football field to scale. A position indicia, a reference indicia, or both can be illustrated across more than one of the different images generated by the different projectors. The exemplary array in FIG. 6 includes six projectors 12 across the width W and eight projectors across the depth D. The exemplary composite image produced by the array can have a width W of one hundred and fifty (150) feet and a depth D of one hundred and fifty-two (152) feet.

CineMassive Displays, of 650-N Hamilton Ave in Atlanta, Ga. 30312,can provide a system by which a plurality of projectors can be controlled to collectively produce an image.

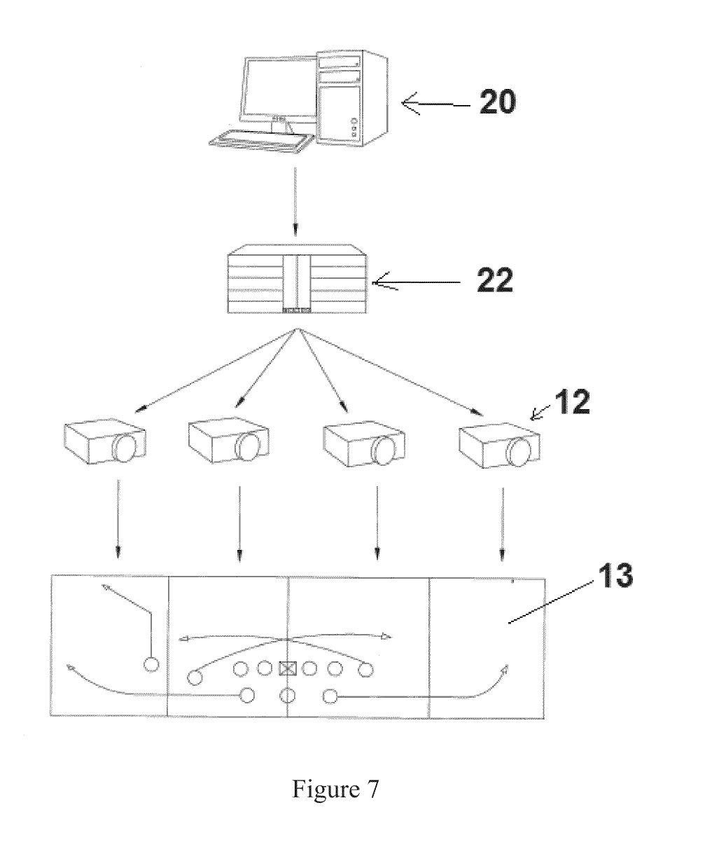

FIG. 7 is a schematic representation of a system for producing a composite image. A computer (laptop, PC, etc) 20 can be used to create and store playbooks which are images and diagrams of an athletic field and positions for each player. The images can be created by any image generating program. The playbook images and diagrams can be made with black lines and text on a white background to maximize contrast. Projecting the image onto a white surface would also help in maximizing contrast. The computer 20 can be connected to an input of a video processor. The video processor 22 has multiple video outputs. The Alpha Server sold by CineMassive can be applied as the video processor in embodiments of the invention, for example. Video projectors 12 are connected to the outputs of the video processor to project respective images. The video processor will extend the viewing space across multiple projectors, a process known as spanning Scaffolding or overhead beams can be applied to mount the projectors 12 at a predetermined distance above the surface. The EIKI LC-X85 projector manufactured by EIKI International Inc., 30251 Esperanza, Rancho Santa Margarita, Calif., 92688, can be applied in embodiments of the invention.

When selecting a video projector for an embodiment of the invention, general categories of consideration include image size, throw distance, contrast ratio, projector lumens and ambient light. The image size of a standard video projector (price range from $2,000-$7,000) can produce an image sized about twenty-five (25) feet wide by nineteen (19) feet deep. For an image that size, the throw distance or distance that the projector can be from the surface is about sixteen (16) feet to twenty-one (21) feet. The contrast ratio relates the brightest color (white) that can be generated to that of the darkest color (black). A high contrast ratio is preferred. The projector lumens is a measure of the total visible light emitted from the projector. A projector with higher lumens will produce more light per viewing area and is desirable. If the ambient light is greater than the projector lumens over the same area then the result would be non-viewable image. Thus, it may be desirable to minimize or eliminate ambient light.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A method of facilitating athletic training comprising the steps of:
projecting an image downwardly on a surface, wherein the projected image displays a plurality of indicia including at least one position indicia corresponding to a participant of an athletic activity and at least one reference indicia at least partially spaced from the at least one position indicia.

2. The method of claim 1 wherein said projecting step further comprises the step of:
displaying the at least one position indicia as a solid and nonlinear geometric shape selected from the group consisting of a circle, a square, a rectangle, an oval, a triangle and an alphanumeric character.

3. The method of claim 1 wherein said projecting step further comprises the step of:
displaying the at least one position indicia at least in part as a line.

4. The method of claim 3 wherein said displaying step is further defined as:
displaying the at least one position indicia progressively at least in part as a line that extends over a period of time perceivable by the participant.

5. The method of claim 3 wherein said displaying step is further defined as:
displaying the at least one position indicia in part as a line and in part as solid and nonlinear geometric shape.

6. The method of claim 1 wherein said projecting step further comprises the step of:
displaying the at least one reference indicia selected from the group consisting of a line, circle, a square, a rectangle, an oval, a piece of athletic equipment, and a triangle.

7. The method of claim 1 wherein said projecting step further comprises the step of:
moving the at least one reference indicia within the image over a period of time perceivable by the participant.

8. The method of claim 1 wherein said projecting step further comprises the step of:
displaying a plurality of position indicia each being in part a line and in part a solid and nonlinear geometric shape.

9. The method of claim 8 said displaying step is further defined as:
displaying the line portions of each of the plurality of position indicia progressively as lengthening over a period of time perceivable by the participant.

10. The method of claim 1 further comprising:
suspending at least one projector above the surface prior to said projecting step.

11. The method of claim 10 wherein said suspending step further comprises:
suspending a plurality of projectors above the surface prior to said projecting step.

12. The method of claim 11 wherein said projecting step further comprises the step of:
displaying different images from each of the plurality of projectors, wherein the different images correspond to one another and cooperate to define a composite image.

13. The method of claim 12 wherein said displaying step further comprises the step of:
illustrating at least one of the position indicia and the reference indicia across more than one of the different images.

14. The method of claim 1 wherein said projecting step is further defined as:
projecting an image downwardly on a surface, wherein the projected image displays a plurality of indicia including a plurality of position indicia each corresponding to a participant of a football game and also including a plurality of reference indicia corresponding to yardage lines of a football field arranged to scale.

15. The method of claim 14 wherein said displaying step is further defined as:
displaying the at least some of the position indicia in part as solid and nonlinear geometric shape and in part as a line extending from the solid and nonlinear geometric shape.

16. The method of claim 1 wherein said projecting step is further defined as:
projecting an image downwardly on a surface, wherein the projected image displays a plurality of indicia including a plurality of position indicia each corresponding to a participant of a baseball game and also including a plurality of reference indicia corresponding to foul lines and bases of a baseball diamond arranged to scale.

17. The method of claim 1 wherein said projecting step is further defined as:
projecting an image downwardly on a surface, wherein the projected image displays a plurality of indicia including a plurality of position indicia each corresponding to a participant of a volleyball game and also including a plurality of reference indicia corresponding to boundary lines and a net of a volleyball court arranged to scale.
